(19) United States
(12) Patent Application Publication
(10) Pub. No.: US 2006/0225361 A1
(43) Pub. Date: Oct. 12, 2006

(54) Articulated window assembly with ball turret hinge

(76) Inventors: Del Wayne Scheer, Oxford, MI (US); Jeff Scott Wilkinson, South Lyon, MI (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 11/100,303

(22) Filed: Apr. 6, 2005

(51) Int. Cl. E05D 7/00

(52) U.S. Cl. 49/397

(57) ABSTRACT

An articulating window assembly is adapted to be pivotably connected to a support structure. The window assembly includes a windowpane having an inner surface and a hinge adjacent the inner surface. The hinge includes a spherical-shaped ball member having a stud extending therefrom and polymeric member secured to the inner surface of the windowpane and at least partially forming a generally spherical shaped cavity receiving the ball member. The polymeric member at least partially encapsulates or surrounds the ball member such that the windowpane is pivotable about the ball member as the polymeric member moves about the ball member.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to an articulating and/or pivoting window and, more particularly, to an articulating and/or pivoting window for a motor vehicle.

### BACKGROUND OF THE INVENTION

In an effort to make automobiles more fuel-efficient, automobile exterior designs are becoming more streamlined. One way to achieve this goal is through the use of flush mounted panel and window assemblies. The design goal is to locate the panel and window assemblies within the vehicle so that the peripheral edge of the panel or window assembly is recessed and the outer surface of the panel or window assembly is flush with any adjoining panels or windows.

Conventional articulating or pivoting window assemblies for motor vehicles, particularly flip windows, have a windowpane which pivots to allow a small amount of air into the motor vehicle. Such windows are used, for example, as side windows on minivans where a latch mount is attached near one edge of the windowpane to receive a latch attached to the motor vehicle. Operation of the latch forces the windowpane to pivot on a hinge near a second edge of the windowpane opposite the latch mount. The hinge is typically a metal bracket bonded to the windowpane with adhesive. For example, see U.S. Pat. Nos. 5,551,197, 6,128,860, and 6,871,450, the disclosures of which are expressly incorporated herein in their entireties by reference. These bonded metal hinges have had problems with adhesive failures when the window assembly is subjected to repeated cycling between open and closed positions.

There have also been attempts to use molded hinges for an articulating window of a motor vehicle. For example, see U.S. Pat. No. 4,777,699, the disclosure of which is expressly incorporated herein in its entirety. Repeated cycling of these window assemblies between open and closed positions, however, places high stresses on the mounting stud assembly which can cause the stud to work its way out of the hinge member.

Attempts have been made to solve these and other problems by using hinges formed of reaction injection molded (RIM) polyurethane or hinge members at least partially encapsulated by RIM polyurethane. See for example U.S. Pat. No. 6,123,383 and U.S. Patent Application Publication Number 2003/0088944A1, the disclosures of which are expressly incorporated herein in their entireties by reference. While these attempts have generally been successful, the motor vehicle industry has a never ending desire to reduce manufacturing costs, reduce packaging size, and to increase strength and/or reduce applied loads. Accordingly, there is a need in the art for an improved articulating window assembly.

### SUMMARY OF THE INVENTION

The present invention provides an articulated window assembly for a motor vehicle which overcomes at least some of the above-noted problems of the related art. According to the present invention, an articulating window assembly comprises, in combination, a windowpane having an inner surface and a hinge adjacent the inner surface. The hinge includes a spherical-shaped ball member having a stud extending therefrom and a socket member secured to the inner surface of the windowpane and at least partially forming a generally spherical shaped cavity receiving the ball member. The windowpane is pivotable about the ball member as the socket member moves about the ball member.

According to another aspect of the present invention, an articulating window assembly comprises, in combination, a windowpane having an inner surface and a hinge adjacent the inner surface. The hinge includes a spherical-shaped ball member having a stud extending therefrom and polymeric member secured to the inner surface of the windowpane and at least partially forming a generally spherical shaped cavity receiving the ball member. The polymeric member at least partially encapsulates or surrounds the ball member such that the windowpane is pivotable about the ball member as the polymeric member moves about the ball member.

According to yet another aspect of the present invention, an articulating window assembly comprises, in combination, a windowpane having an inner surface and a hinge adjacent the inner surface. The hinge includes a spherical-shaped ball member having a stud extending therefrom and polymeric member secured to the inner surface of the windowpane and at least partially forming a generally spherical shaped cavity receiving the ball member. The polymeric member includes a base plate at least partially forming the socket at a side of the ball member opposite the windowpane and the base plate has an opening for passage of the stud therethrough. The polymeric member includes a sealing plate at least partially forming the cavity to limit entry of unwanted material into the cavity. The stud engages an edge of the opening to limit outer pivoting of the window pane. The polymeric member at least partially encapsulates or surrounds the ball member such that the windowpane is pivotable about the ball member as the polymeric member moves about the ball member.

From the foregoing disclosure and the following more detailed description of various preferred embodiments it will be apparent to those skilled in the art that the present invention provides a significant advance in the technology and art of articulating window assemblies for motor vehicles. Particularly significant in this regard is the potential the invention affords for providing a high quality, reliable, low cost assembly having a relatively small package size. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a flush mounted articulating window assembly in a motor vehicle according to a preferred embodiment of the present invention;

FIG. 2 is an elevational view of the inner side of the articulating window assembly of FIG. 1, wherein body panels of the motor vehicle are removed for clarity;

FIG. 3 is a cross sectional view taken along line 3-3 of FIG. 2, wherein the window assembly is in a closed position;

FIG. 4 is a cross sectional view similar to FIG. 3 but showing the window assembly in an open position; and

FIG. 5 is an enlarged, fragmented perspective view showing a hinge of the window assembly of FIGS. 1 to 4, wherein the windowpane has been removed for clarity.

It should be understood that the appended drawings are not necessarily to scale, presenting a somewhat simplified representation of various preferred features illustrative of the basic principles of the invention. The specific design features of an articulating window assembly as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the shifter lever mechanism illustrated in the drawings. In general, up or upward generally refers to an upward direction in FIG. 1 and down or downward generally refers to a downward direction in FIG. 1. Also in general, fore or forward refers to a direction toward the front of the vehicle, that is, generally toward the right in FIG. 1 and aft or rearward refers to a direction toward the rear of the vehicle, that is, generally toward the left in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved articulating window assemblies disclosed herein. The following detailed discussion of various alternative and preferred embodiments will illustrate the general principles of the invention with reference to a flush mounted window assembly for use as a side window on a minivan type motor vehicle. Other embodiments suitable for other applications, such as three-sided flip windows and articulating windows for pickup trucks, sport utility vehicles, cross-over vehicles, or van conversions will be apparent to those skilled in the art given the benefit of this disclosure.

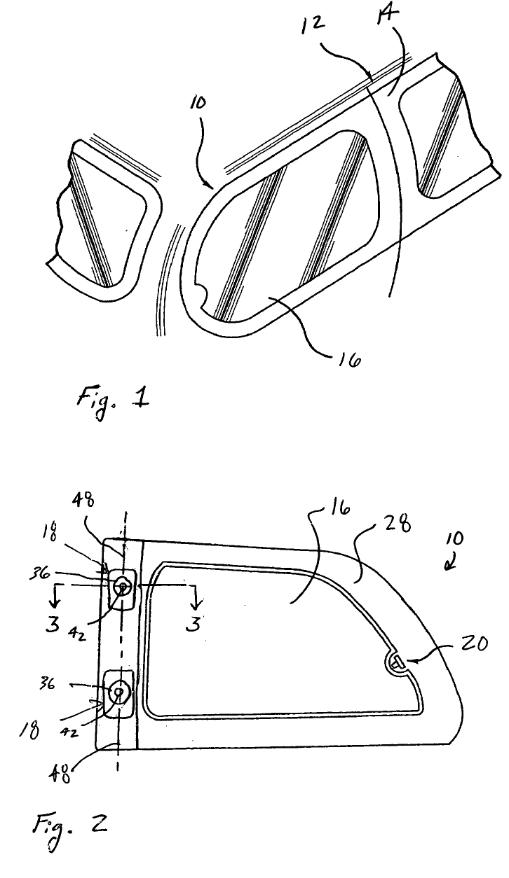

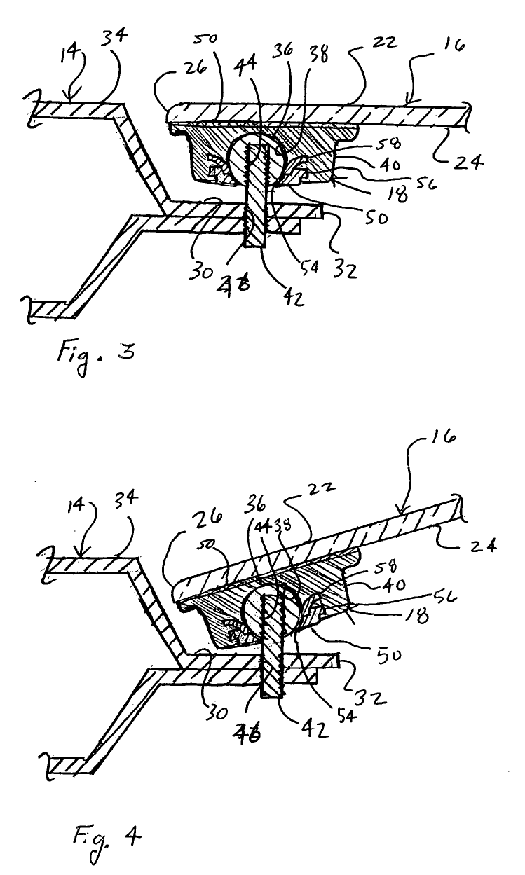

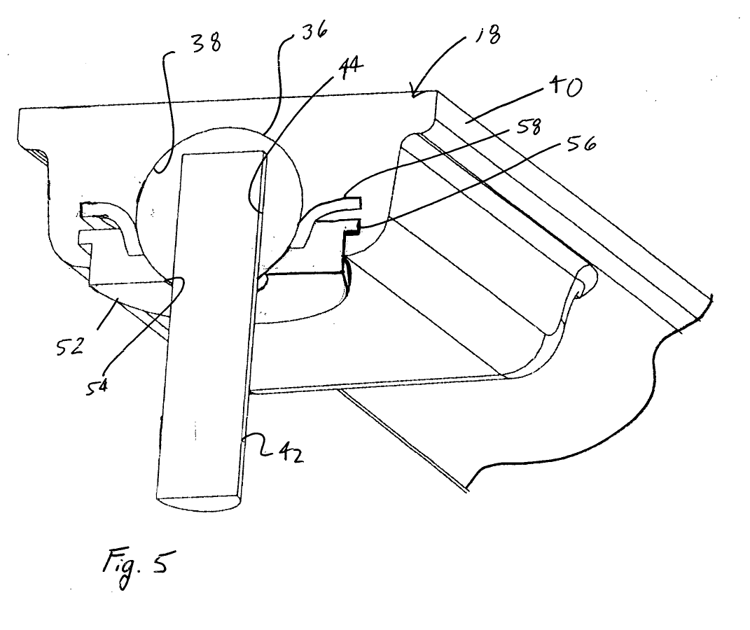

Referring now to the drawings, FIGS. 1 to 4 show an articulating window assembly 10 of a motor vehicle 12 according to a preferred embodiment of the present invention. The articulating window assembly 10 is located within a body panel or support structure 14 of the motor vehicle 12 such that it is selectively pivotable between a closed position (best shown in FIGS. 1 to 3) and an open position (best shown in FIG. 4). The illustrated window assembly 10 includes a windowpane 16, a pair of hinges 18 pivotably attaching a first or forward edge of the windowpane 16 to the body panel 14, and a latch member 20 releasably securing a second or rear edge of the windowpane 16 to the body panel. The latch member 20 can be of any suitable type.

The illustrated windowpane 16 has an outer surface 22, an inner surface 24, and a peripheral edge 26. The windowpane 16 can be of any desirable size and shape. An opaque frit 28 can be positioned around the peripheral edge 26 of the windowpane 16 to conceal the hinges 18 and the latch member 20. Where the windowpane 16 is made of glass, the frit 28 is commonly a ceramic frit.

The illustrated window assembly 10 is located in a recess defined by a peripheral ledge 30 of the body panel 14 which surrounds an opening 32 so that the window assembly 10 selectively opens and closes the opening 32. The illustrated outer surface 22 of the windowpane 16 is positioned substantially flush with an exterior surface 34 of the body panel 14. Optionally, a conventional seal assembly may be positioned around the window assembly 10 and/or opening 32 to prevent water, dirt and the like from entering the motor vehicle 12 through the opening 32 when the window assembly 10 is in its closed position.

The illustrated window assembly 10 is pivotably secured to the body panel 13 by the pair of vertically spaced apart hinges 18. It is noted that alternatively the window assembly 10 can be secured with other quantities of the hinges 18. The illustrated hinges 18 are identical so only one hinge 18 will be described in detail hereinafter. The illustrated hinges 18 are ball turret or ball and socket type hinges. The illustrated hinges 18 each include a ball member 36 and a socket 38 formed by a socket or polymeric member 40. The illustrated ball member 36 is substantially spherical-shaped and has a cylindrical rod or stud 42 rigidly secured thereto and extending from an inner side thereof. The illustrated stud 42 has a first or outer threaded end extending into a blind threaded bore or opening 44 of the ball member 36 so that the stud 42 is rigidly threaded to the ball member 36 to substantially prevent relative movement therebetween. It is noted that the stud 42 can alternatively be attached to the ball member 36 in any other suitable manner and can alternatively be formed unitary as one piece with the ball member 36. The illustrated stud 42 has a second or inner threaded end extending into an opening 46 of the body panel peripheral ledge 30 so that the stud 42 and the ball member 36 are rigidly secured to the body panel 14 to substantially prevent relative movement therebetween. It is noted that the stud 42 can alternatively be attached to the body panel 14 in any other suitable manner. Mounted in this manner, the ball member 36 forms a substantially vertical pivot axis 48 for the windowpane 16. The ball member 36 can comprise a zinc casting, powder metal or any other suitable material. The stud 42 can comprise tool steel or any other suitable material.

The illustrated polymeric member 40 vertically extends along the forward or first edge of the window assembly 10 at the inner surface 24 of the windowpane 16 to partially encapsulate both of the hinges 18. It is noted that alternatively separate polymeric members 40 can be utilized for the pair of hinges 18. It is also noted that alternatively the polymeric member 40 can extend around any portion or the entire periphery of the windowpane 16 and/or can extend about the peripheral edge 26 of the windowpane 16 to the outer surface 22 of the windowpane 16. The polymeric member 40 is bonded to the windowpane 16 to substantially prevent relative movement therebetween. The illustrated polymeric member 40 partially forms the spherically-shaped socket 38 about the ball member 36 and pivotably secures the ball member 36 to the windowpane 16.

The polymeric member 40 preferably comprises a reaction injection molded (RIM) polyurethane material formed by injection molding a polyol and an isocyanate together into a mold cavity of a heated mold. The shape of the mold cavity will determine the shape of the polymeric member 40. Alternative suitable polymeric materials for the polymeric member 40 include polyvinyl chloride, thermoplastic, thermoplastic elastomers, and elastomers such as EPDM, butyl rubber, silicone, and neoprene. Other suitable materials will be apparent to those skilled in the art given the benefit of this disclosure.

Primer or adhesive 50 is applied conventionally on the inner surface 24 of the windowpane 16 prior to application of the polymeric member 40 to the windowpane 16. The primer 50 is applied to the windowpane 16 where the polymeric member 40 will be bonded to the windowpane 16. When the polymeric member 40 is formed of RIM material and the windowpane 16 has a surface made of soda-lime-silica glass, the primer 50 is preferably a silane primer. Examples of silane primers include Chemlok® 144 and Chemlok® AP-134 manufactured by the Lord Corporation of Erie, Pa. Other combinations of primers and polymeric materials will be apparent to those skilled in the art given the benefit of this disclosure.

The ball member 36 is optionally coated with a layer of barrier coat such as Monocoat® 1021w or Monocoat® 472w manufactured by Chem-Trend Inc. of Howell, Mich. to prevent the polymeric material of the polymeric member 40 from adhering to the ball member 36. The barrier coat assures that the polymeric member 40 does not prevent the ball member 36 from pivoting within the socket 38 when surrounded by the polymeric member 40.

Optionally, a barrel or base plate 52 is included to increase the pull-out strength of the ball member 36 from the polymeric member 40. The illustrated base plate 52 is generally disc-shaped and located at the inner surface of the polymeric member 40 opposite the windowpane 16. The illustrated base plate 52 has a central opening 54 for passage of the ball member 36 and/or the stud 42 and is shaped to partially form the socket 38 about the opening 54. As described in more detail hereinafter, the opening 54 is preferably sized to provide an outer hard stop, that is an outer limit, for the window assembly 10. The illustrated base plate 52 also includes a wing or flange 56 radially extending from an outer side of the base plate 52. The flange 56 increases surface area of the base plate 52 and forms an interlock with the polymeric member 40 to increase the pull out strength of the base plate 52 from the polymeric member 40. It is noted that the base plate 52 can alternatively have any other suitable shape. The base plate 52 can comprise a zinc casting, powder metal or any other suitable material.

Optionally, a flexible boot or sealing plate 58 is included to allow movement while preventing unwanted flow of material into the socket 38 to impede movement of the ball member 36. The illustrated sealing plate 58 is located outwardly adjacent the base plate 52. The illustrated sealing plate 58 is generally ring or annular shaped having an inwardly turned inner edge engaging the base plate 52 at the socket 38 and partially forming the socket 38 and a radially extending outer edge generally parallel to and spaced apart from the flange 56 of the base plate 52. Located in this manner, the sealing plate 58 engages the ball member 36 near the opening 54 to seal the socket 38 and substantially prevent entry of unwanted material into the socket 38. It is noted that the sealing plate 58 provides a robust shutoff platform to prevent the unwanted flow of encapsulation material onto the ball member 36. It is noted that the sealing plate 58 can alternatively have any other suitable shape. The sealing plate 58 can comprise a plastic material such as Nylon, a spring metal or any other suitable material.

Preferably, manufacturing of the window assembly 10 is accomplished by inspecting, preparing and cleaning the windowpane 16. Primer 50 is then applied to a portion of the inner surface 24 of the windowpane 16. The ball member 36, the base plate 52, and the sealing plate 58 are inserted into the cavity of a mold and the mold is closed. Next, curable polymeric material is injected to into the mold cavity, forming the polymeric member 40 to at least partially encapsulating the ball member 36 and bonding the polymeric member 40 to the inner surface 24 of the windowpane 16. The window assembly 10 is then be removed from the mold cavity. It is noted that the encapsulation mold assures positive location of component parts relative to the windowpane 16 dictating positional tolerance and edge stops on the flange 56 of the base plate 52 control movement of the component within the mold.

In operation, when an operator or passenger in the motor vehicle 12 desires to open the window assembly 10, the latch member 20 is disengaged, thereby permitting the windowpane 16 to be articulated and or pivoted outward of the motor vehicle about the hinges 18. The hinges 18 permit the windowpane 16 to pivot about the pivot axes 48 as the polymeric members 40 and the windowpane 16 secured thereto move about the ball members 36 which are rigidly secured to the motor vehicle body panel 14 by the studs 42. The cavities 38 preferably permit the ball members 36 to oscillate or articulate to aid the windowpane 16 in moving between its open and closed positions. Therefore, movement occurs within the hinges 18 without flexing of sheet metal or polymeric material and the encapsulation material defuses input loads on the windowpane 16. The windowpane 16 can be pivoted outward until a maximum outward opening angle is reached when the stud 42 engages the edge of the base plate opening 54. It should be appreciated that the maximum outward opening angle can be predetermined and preset by appropriately sizing the opening 54 in the base plate 52.

It is apparent from the above detailed description of the present invention, that the illustrated articulating window assembly 10 reduces required packaging depth, reduces external stress on the substrate (the windowpane 16), and eliminates the need for a common pivot axis which allows more packaging freedom and requires less space.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. An articulating window assembly comprising, in combination:
a windowpane having an inner surface;
a hinge adjacent the inner surface, the hinge including a spherical-shaped ball member having a stud extending therefrom and a socket member secured to the inner surface of the windowpane and at least partially forming a generally spherical shaped cavity receiving the ball member; and
wherein the windowpane is pivotable about the ball member as the socket member moves about the ball member.

2. The articulating window assembly according to claim 1, wherein the stud is rigidly secured to the ball member with a threaded connection.

3. The articulating window assembly according to claim 1, wherein the socket member comprises a polymeric material at least partially encapsulating the ball member.

4. The articulating window assembly according to claim 3, wherein socket member comprises a reaction injection molded polymeric material to secure the socket member to the inner surface of the windowpane.

5. The articulating window assembly according to claim 3, wherein the polymeric material comprises one of an elastomer, a thermoplastic, a thermoset plastic, and a polyurethane.

6. The articulating window assembly according to claim 3, wherein the socket member includes a base plate at least partially forming the socket at a side of the ball member opposite the windowpane.

7. The articulating window assembly according to claim 3, wherein the base plate includes an opening for passage of the stud therethrough.

8. The articulating window assembly according to claim 7, wherein the stud engages an edge of the opening to limit outer pivoting of the window pane.

9. The articulating window assembly according to claim 3, wherein the socket member includes a sealing plate at least partially forming the cavity to limit entry of unwanted material into the cavity.

10. The articulating window assembly according to claim 9, wherein the sealing plate comprises a flexible material.

11. An articulating window assembly comprising, in combination:
a windowpane having an inner surface;
a hinge adjacent the inner surface, the hinge including a spherical-shaped ball member having a stud extending therefrom and polymeric member secured to the inner surface of the windowpane and at least partially forming a generally spherical shaped cavity receiving the ball member;
wherein the polymeric member at least partially encapsulates the ball member so that the windowpane is pivotable about the ball member as the polymeric member moves about the ball member.

12. The articulating window assembly according to claim 11, wherein the stud is rigidly secured to the ball member with a threaded connection.

13. The articulating window assembly according to claim 1 1, wherein polymeric member comprises a reaction injection molded polymeric material to secure the polymeric member to the inner surface of the windowpane.

14. The articulating window assembly according to claim 11, wherein the polymeric member comprises one of an elastomer, a thermoplastic, a thermoset plastic, and a polyurethane.

15. The articulating window assembly according to claim 11, wherein the polymeric member includes a base plate at least partially forming the socket at a side of the ball member opposite the windowpane.

16. The articulating window assembly according to claim 11, wherein the base plate has an opening for passage of the stud therethrough.

17. The articulating window assembly according to claim 16, wherein the stud engages an edge of the opening to limit outer pivoting of the window pane.

18. The articulating window assembly according to claim 11, wherein the polymeric member includes a sealing plate at least partially forming the cavity to limit entry of unwanted material into the cavity.

19. The articulating window assembly according to claim 18, wherein the sealing plate comprises a flexible material.

20. An articulating window assembly comprising, in combination:
a windowpane having an inner surface;
a hinge adjacent the inner surface, the hinge including a spherical-shaped ball member having a stud extending therefrom and polymeric member secured to the inner surface of the windowpane and at least partially forming a generally spherical shaped cavity receiving the ball member;
wherein the polymeric member includes a base plate at least partially forming the socket at a side of the ball member opposite the windowpane and the base plate has an opening for passage of the stud therethrough;
wherein the polymeric member includes a sealing plate at least partially forming the cavity to limit entry of unwanted material into the cavity;
wherein the stud engages an edge of the opening to limit outer pivoting of the window pane; and
wherein the polymeric member at least partially encapsulates the ball member such that the windowpane is pivotable about the ball member as the polymeric member moves about the ball member.
